(19) United States
(12) Patent Application Publication
(10) Pub. No.: US 2008/0163363 A1
(43) Pub. Date: Jul. 3, 2008

(54) IMAGE PROCESSING APPARATUS AND PERSONAL INFORMATION MANAGEMENT PROGRAM

(75) Inventor: Akihiro MIZUTANI, Ota-ku (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 12/047,755

(22) Filed: Mar. 13, 2008

Related U.S. Application Data
(62) Division of application No. 10/796,132, filed on Mar. 10, 2004.

(51) Int. Cl. G06F 21/00

(52) U.S. Cl. 726/19

(57) ABSTRACT

An image processing apparatus and a personal information management program are provided in which each user is permitted to perform the processing of user's own personal information while preventing leakage of user's personal information without disturbing the use of the apparatus by an infinite number of users to any substantial extent. The apparatus includes a user authentication section that acquires ID information to identify each user from among a plurality of users, and performs user authentication based on the ID information; an operation mode setting section that can selectively set, as an operation mode that sets a work environment for operation inputs, between an personal operation mode to permit each user to operate individually and a public operation mode to permit an indefinite number of users to operate; and a mode switching section that, when a user is authenticated in the user authentication section, switches the operation mode from the public operation mode into the personal operation mode for the authenticated user.

The present application is a divisional of U.S. application Ser. No. 10/796,132, filed Mar. 10, 2004, the entire contents of which are incorporated herein by reference.

### BACKGROUND OF THE INVENTION

1. Field of the Invention

The present invention relates to an image processing apparatus and a personal information management program.

2. Description of the Related Art

In the past, there has been disclosed a technique which is constructed such that by authenticating a user through personal authentication in a computer terminal which is used by a plurality of users, the user is permitted to perform the processing of personal information such as checking of mails addressed to the user concerned, browsing of bulletin board webs, etc., while preventing leakage of private information, etc., (Japanese patent application laid-open No. 2003-167848).

In order to authenticate each of a plurality of users and permit each user to perform processing of his or her personal information as in the known technique mentioned above, it is usual to especially install a terminal that is shared by the plurality of users concerned, which leads to a problem that such a common terminal is expensive and needs the space for installation thereof.

In view of such a problem, there is demanded a technique that can enable image processing apparatuses generally installed in offices to perform the processing of personal information while preventing the leakage of private information etc.

However, in general, image processing apparatuses are often installed in environments in which an indefinite number of users can make use of them, so it is necessary to achieve the protection of personal information without disturbing the use of such apparatuses by the indefinite number of users to any substantial extent.

### SUMMARY OF THE INVENTION

The present invention has been made to solve the problem as referred to above, and has for its object to provide an image processing apparatus and a personal information management program which can permit each user to perform the processing of his or her own personal information while preventing leakage of user's personal information without disturbing the use of the apparatus by an infinite number of users to any substantial extent.

In order to solve the problem as mentioned above, an image processing apparatus according to one aspect of the present invention is constructed to comprise: a user authentication section that acquires ID information to identify each user from among a plurality of users, and performs user authentication based on the ID information; an operation mode setting section that can selectively set, as an operation mode that sets a work environment for operation inputs, between an personal operation mode to permit each user to operate individually and a public operation mode to permit an indefinite number of users to operate; and a mode switching section that, when a user is authenticated in the user authentication section, switches the operation mode from the public operation mode into the personal operation mode for the authenticated user.

By making the operation mode for setting the work environment for operation inputs selectable between different operation modes depending upon the cases where an indefinite number of general users are permitted to operate and where specific users are permitted to operate individually, it is possible for each user to perform the processing of his or her own personal information while preventing leakage of user's personal information without disturbing the use of the indefinite number of users to any substantial extent.

In addition, preferably, in the personal information management apparatus as stated above, the mode switching section switches the operation mode from the personal operation mode into the public operation mode based on a prescribed condition with the state that a current operation mode is set to the personal operation mode.

By making it possible to switch the operation mode into the public operation mode based on the prescribed condition in this manner, the situation that an indefinite number of users operate the apparatus with the operation mode set to the personal operation mode can be avoided.

Moreover, preferably, in the personal information management apparatus as stated above, when ID information is not acquired for a period of time longer than a predetermined time in the user authentication section, the mode switching section switches the operation mode from the personal operation mode into the public operation mode with the state that a current operation mode is set to the personal operation mode.

According to such a construction, for example, in cases where ID information can be acquired in the user authentication section only when the user performs operation in the image processing apparatus (e.g., in case of personal authentication being performed by a user's fingerprint, etc.), even when the user, who had been operating the apparatus in the personal operation mode was away from the apparatus with its operation mode being kept set to the personal operation mode for a predetermined time or more, or when the user finished the operation inadvertently while having forgotten that the apparatus had been set to the personal pertain mode, or the like, it is possible to avoid the situation where an indefinite number of users operate the apparatus with its operation mode being set to the personal operation mode.

Of course, the present invention is not limited to this but it can be constructed such that the image processing apparatus further comprises a human body detection section that detects a user located in the vicinity of the image processing apparatus, wherein when a human body has not been detected by the human body detection section for a period of time longer than a predetermined time. the mode switching section switches the operation mode from the personal operation mode into the public operation mode with the state that a current operation mode is set to the personal operation mode.

According to such a construction, when the user, who had been operating the apparatus in the personal operation mode was away from the apparatus with its operation mode being kept set to the personal operation mode for a predetermined time or more, or when the user finished the operation inadvertently while having forgotten that the apparatus had been set to the personal operation mode, or the like, it is possible to avoid the situation where an indefinite number of users operate the apparatus with its operation mode being set to the personal operation mode.

Further, preferably, the personal information management apparatus as stated above further comprises a setting information acquisition section that acquires setting information associated with each user, wherein the operation mode setting section sets the personal operation mode based on the setting information associated with the user authenticated in the user authentication section.

With such a construction, by arbitrarily changing the content of the setting information associated with each user, it is possible to easily customize the setting content of the individual operation mode.

Besides, preferably, in the personal information management apparatus as stated above, the ID information cooperates with login IDs in a network that can be connected to the image processing apparatus, wherein the image processing apparatus can further comprise a personal information processing section that performs the processing of personal information relevant to the users corresponding to the ID information existing on the network based on the ID information.

A personal information management program according to another aspect of the present invention is constructed such that the personal information management program, which is adapted to be stored in a computer-readable medium so as to perform the management of personal information in an image processing apparatus shared by a plurality of users, serves to make a computer execute: a user authentication step that acquires ID information to identify each user from among a plurality of users, and performing user authentication based on the ID information: an operation mode setting step that selectively sets, as an operation mode that sets a work environment for operation inputs, between an personal operation mode to permit each user to operate individually and a public operation mode to permit an indefinite number of users to operate; and a mode switching step that, when a user is authenticated in the user authentication step, switches the operation mode from the public operation mode into the personal operation mode for the authenticated user.

Furthermore, preferably, in the personal information management program as stated above, in the mode switching step, the operation mode is switched from the personal operation mode into the public operation mode based on a prescribed condition with the state that a current operation mode is set to the personal operation mode.

Still further, preferably, in the personal information management program as stated above, in the mode switching step, when ID information is not acquired for a period of time longer than a predetermined time in the user authentication step, the operation mode can be switched from the personal operation mode into the public operation mode with the state condition that a current operation mode is set to the personal operation mode.

In addition, preferably, the personal information management program as stated above further comprises a human body detection step for detecting a user located in the vicinity of the image processing apparatus, wherein in the mode switching step, when a human body has not been detected in the human body detection step for a period of time longer than a predetermined time, the operation mode may be switched from the personal operation mode into the public operation mode with the state that a current operation mode is set to the personal operation mode.

Besides, preferably, the personal information management program as stated above can further comprise a setting information acquisition step that acquires setting information associated with each user, wherein in the operation mode setting step, the personal operation mode is set based on the setting information associated with the user authenticated in the user authentication step.

Further, preferably, in the personal information management program as stated above, the ID information cooperates with login IDs in a network that can be connected to the image processing apparatus, wherein the personal information management program may further comprise a personal information processing step that performs the processing of personal information relevant to the users corresponding to the ID information existing on the network based on the ID information.

### BRIEF DESCRIPTION OF THE DRAWINGS

FIG. 1 is a block diagram of an image processing apparatus according to a first embodiment of the present invention.

FIG. 2 is a flow chart explaining the flow of processing in the image processing apparatus according to this embodiment.

FIG. 3 is a screen display example in a display screen or display section of an unillustrated card reader.

FIG. 4 is a view explaining the data structure of setting information.

FIG. 5 is a screen display example in the display section that is set to an operation mode for a user having an ID of “A”.

FIG. 6 is a screen display example in the display section when a “Print” button is pressed.

FIG. 7 is a screen display example in the display section that is set to as operation mode for a user having an ID of “B”.

FIG. 8 is a screen display example in the display section when an “Arrival” button is pressed.

FIG. 9 is a flow chart explaining the flow of processing in an image processing apparatus according to a second embodiment of the present invention.

FIG. 10 is a flow chart explaining the flow of processing in the image processing apparatus according to this second embodiment.

FIG. 11 is a view showing one example of a display screen created at a time record information processing section.

FIG. 12 is a flow chart explaining the flow of processing in the image processing apparatus according to this second embodiment.

FIG. 13 is a flow chart explaining the flow of processing in the image processing apparatus according to this second embodiment.

FIG. 14 is a flow chart explaining the flow of processing in the image processing apparatus according to this second embodiment.

FIG. 15 is a view explaining schedule information displayed in the display section by a schedule information processing section.

FIG. 16 is a flow chart explaining the flow of processing in the image processing apparatus according to this second embodiment.

### DESCRIPTION OF THE PREFERRED EMBODIMENTS

Hereinafter, preferred embodiments of the present invention will be described in detail while referring to the accompanying drawings.

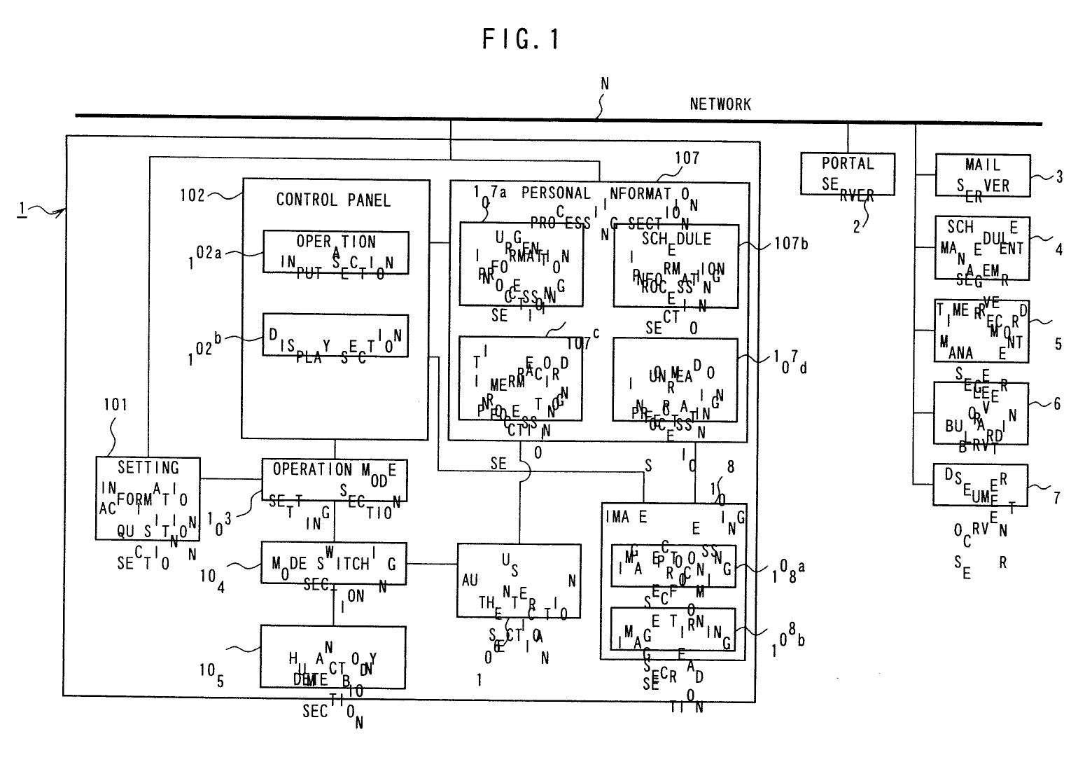

The functional block diagram of an image processing apparatus according to this embodiment is shown in FIG. 1. Here, note that an MFP (Multi Function Peripheral) for example is concretely enumerated as the image processing apparatus.

As shown in this figure, the image processing apparatus 1 according to this embodiment is connected to a network N to which are connected a portal server 2, a mail server 3, a schedule management server 4, a time record management server 5, a bulletin board server 6, and a document server 7 for communication therewith. With such an arrangement, the image processing apparatus 1 becomes able to communicate with these servers.

The image processing apparatus 1 includes a setting information acquisition section 101, a control panel 102, an operation mode setting section 103, a mode switching section 104, a human body detection section 105, a user authentication section 106, a personal information processing section 107, an image processing section 108, an unillustrated CPU and an unillustrated the storage section.

The control panel 102 is constituted by an operation input section 102a and a display section 102b, and the personal information processing section 107 is constituted by an urgent information processing section 107a, a schedule information processing section 107b, a time record information processing section 107c, and an unread information processing section 107d. Also, the image processing section 108 is constituted by an image forming section 108a and an image reading section 108b.

Now, reference will be made in detail below to the respective component elements of the image processing apparatus according to the first embodiment of the present invention.

The setting information acquisition section 101 has a role to acquire setting information (to be described later) stored in the portal server 2.

The control panel 102 is constituted by the operation input section 102a by which a user can perform operation inputs to the apparatus and a display section 102b for performing a screen display. The control panel 102 can be constructed to provide, for example, with a touch panel display etc.

The operation mode setting section 103 has a role to set, as operation modes for setting the work environment for operation inputs in the control panel 102, a public operation mode to permit an indefinite number of users to operate and a personal or individual operation mode to permit each user to individually operate (operation mode setting step).

The mode switching section 104 has a role to switch between the operation modes set by the operation mode setting section 103, so that when a user is authenticated in the user authentication section 106 (to be described later), it switches the operation mode from the public operation mode into the personal operation mode for the authenticated user.

The human body detection section 105 has a role to detect a user who locates in the vicinity of the image processing apparatus, and it is constituted by an infrared sensor, for instance.

The user authentication section 106 has a role to acquire ID information for identifying each user from among a plurality of users, and to perform user authentication based on the ID information. As a method of acquiring ID information, there are enumerated inputting of an ID and a password, reading of ID information recorded in an IC card by a card reader, a biometric authentication using a fingerprint or the like, etc. Besides these, any appropriate method can be applied if it is a method of enabling stringent personal authentication.

The personal information processing section 107 has a role to process, based on the ID information of the user authenticated in th above-mentioned user authentication section 106, personal information (for example, the information managed in the mail server 3, the schedule management server 4, the time record management server 5, the bulletin board server 6, and the document server 7) concerning the user corresponding to the ID information existing on the network N. In addition, a login ID to the network N, a login ID to the mail server 3, the schedule management server 4, the time record management server 5, the bulletin board server 6, and the document server 7 and the ID information of the user authenticated in the user authentication section 106 cooperate with one another so as to make it possible for the user to log in the network N and the respective servers by the use of the authenticated ID information.

The urgent information processing section 107a has s role to acquire a list of e-mails containing a character string “urgent” in their titles or texts from among those e-mails which are managed in the mail server 3 in association with the ID information of the user authenticated in the user authentication section 106, and a role to acquire a list of messages containing a character string “urgent” in their titles and texts from among those messages which are managed in the bulletin board server 6 in associated with the ID information of the user authenticated in the user authentication section 106.

Although the character string “urgent” is exemplified here, other character strings “express”, “importance”, etc., beside this can be contained as such a condition. Moreover, the acquisition of e-mails or messages on bulletin boards can include not only the acquisition of the list but also the acquisition of e-mails or messages themselves.

The schedule information processing section 107b has a role to acquire a list or schedules managed in the schedule management server 5 in association with the ID information of the user authenticated in the user authentication section 106.

The time record information processing section 107c has a role to acquire and process information on the arrival and departure times of each employee managed in the time record management server 5 in cooperation with the authentication of user's ID information in the user authentication section 106.

The unread information processing section 107d has a role to acquire a list of unread e-mails received, or a list of unread documents updated, a predetermined time ago along with the authentication of ID information from the mail server 3 or the bulletin board server 6.

Here, note that these urgent information processing section 107a through unread information processing section 107d each have a role to create the data so as to display the acquired information on the display section 102b as well as a role to make the acquired information be printed out in the image forming section 108a (to be described later).

Next, the image processing section 108 are constituted by the image forming section 108a and the image reading section 108b.

The image forming section 108a has a role to perform image forming operation under an instruction from the control panel 102 or the personal information processing section 107. Also, the image reading section 108b has a role to perform image reading operation under an instruction from the control panel 102 or the personal information processing section 107.

The portal server 2 stores therein the setting information associated with the ID information of each user (data to let an individual portal screen displayed for each user identified).

The mail server 3 manages information on the e-mails of each user, and it is constructed to return a response or answer upon receipt of a request from the personal information processing section 107. The mail server 3 has a function to return, as a response or answer, information in the form of a list of e-mails (topics (Subjects) and e-mail IDs (Mailid)) upon receipt of the ID information of a user, as well as to return, upon receipt of ID information and “Mailids”, the e-mail texts corresponding to the Mailids, respectively.

The scheduling management server 4 manages information on the schedule of each user, and is constructed to return a response or answer upon receipt of a request from the personal information processing section 107. Here, note that the schedule management server 4 has a function to return, as a response or answer to the receipt of user's ID information, information on schedules (date and time (day), the ID of the schedules (dayid) corresponding to the date and time, and information on links to their contents (contentslink)), a function to return the schedules corresponding to the dayid upon receipt of ID information and “dayid”, a function to issue a request for outputting designated documents to the document server 7 upon receipt of ID information and “information on the acquisition of contents (getClink)”, and a function to register the designated documents in the document server upon receipt of ID information and “information on the registration of contents (setClink)”.

The time record management server 5 manages information on the time record (arrival and departure times) of each user, and is constructed to return a response or answer upon receipt of a request from the personal information processing section 107. Here, note that the time record management server 5 has a function to acquire, upon receipt of user's ID information and an instruction or command to register “arrival”, the current time point, to return that time point to the personal information processing section 107, and to send the ID information to the bulletin board server 6, and a function to acquire, upon receipt of user's ID information and an instruction or command to register “departure”, the current time point, to return that time point to the personal information processing section 107, and to send the ID information to the bulletin board server 6.

The bulletin board server 6 is constructed such that it returns a response or answer upon receipt of a request from the personal information processing section 107 or the time record management server 5. Here, note that the bulletin board server 6 has a function to return, as a response or answer to the receipt of ID information, contents relevant to the schedules corresponding to the ID.

The document server 7 is constructed to return a response or answer upon receipt of a request for document registration or document output from the personal information processing section 107. Here, note that the document server 7 cooperates with the schedule management server 4, and it has a function to return, as a response or answer to the receipt of user s ID information and “getClink”, the documents corresponding to the “getClink”, and a function to register, as a response or answer to the receipt of ID information and “setClink”, the documents corresponding to the “setClink”.

In this embodiment, an example is illustrated in which user's personal authentication is performed by using an ID card in which ID information is stored. The reading of ID information from this ID card is carried out by an unillustrated card reader installed in the image processing apparatus according to this embodiment, and the ID information thus read by the card reader is acquired by the user authentication section 106. In this connection, though the ID information acquired in the user authentication section 106 includes an “ID”, a “password”, etc., for example, it is not set limited to these but may be any other information that is capable of identifying the respective users.

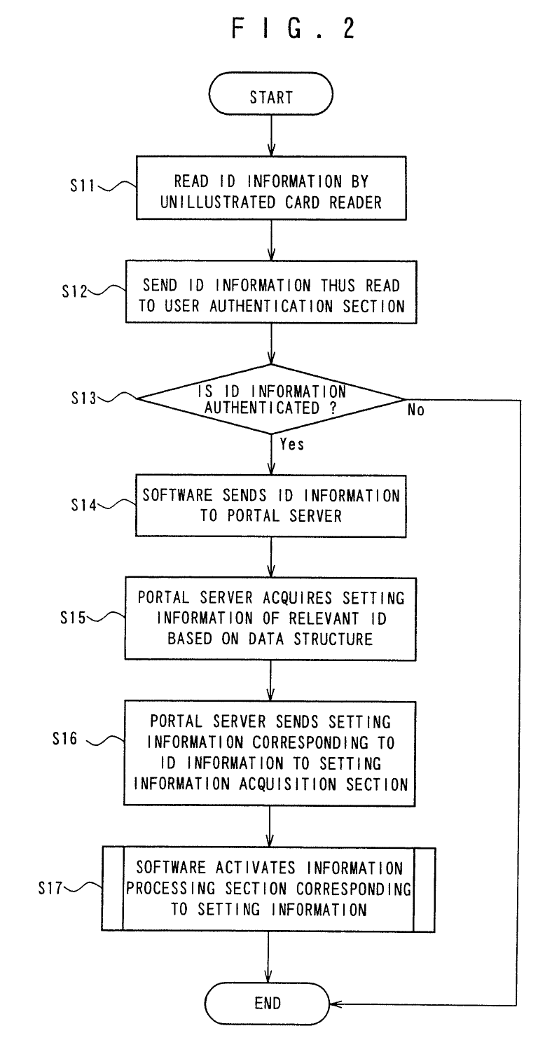

Next, the flow of processing in the image processing apparatus according to this embodiment will be explained using a flow chart of FIG. 2.

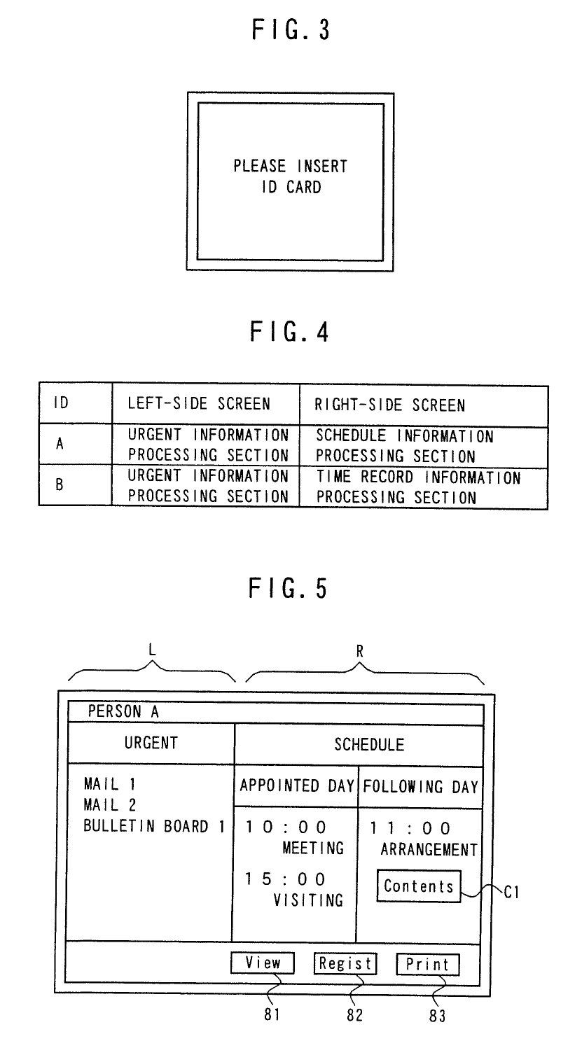

First of all, the operation mode in the image processing apparatus 1 is set to a “public operation mode”. At this time, the display section 102b becomes a screen representation to accept operation inputs by an indefinite number of users for image formation processing and image reading processing. An unillustrated card reader installed in the image processing apparatus 1 is equipped with an unillustrated display screen, on which or on the display section 102 there is displayed a screen as shown in FIG. 3 when the operation mode is set to the “public operation mode”.

When the ID card with user's ID information stored therein is read by the unillustrated card reader (S11), the ID information thus read is sent to the user authentication section 106 (S12).

The user authentication section 106 acquires the ID information sent from the unillustrated card reader, and collates or verifies the ID information thus acquired with data for ID information authentication that is stored in an unillustrated storage section or possessed by the user authentication section 106 (user authentication step) (S13).

When the authentication of the acquired ID information is successful (S13, Yes), the user authentication section 106 sends the ID information concerned to the portal server 2 (S14).

The portal server 2 acquires a piece of setting information associated with a piece of ID information sent from the user authentication section 106 from among a plurality of pieces of setting information stored in association with a plurality of pieces of ID information (setting information acquisition step) (S15), and sends the setting information thus acquired to the setting information acquisition section 101 (S16). The setting information herein takes a data structure as shown in FIG. 4, for example. In this figure, the user of an ID “A” has a subscreen, which is created by the urgent information processing section, displayed at the left side of the screen of the display section 102b, and another subscreen, which is created by the schedule information processing section, displayed at the right of the screen of the display section 102b. Also, the user of an ID “B” has a subscreen, which is created by the urgent information processing section, displayed at the left side of the screen of the display section 102b, and a subscreen, which is created by the time record information processing section, displayed at the right side of the screen of the display section 102b.

The setting content of such a personal operation mode, that is, setting for screen representation (how to split and display a screen, how to allocate the subscreens created by the urgent information processing section 107a through the unread information processing section 107d to splitted screen display areas, etc.) can be changed arbitrarily for each user.

The setting information acquired by the setting information acquisition section 101 is sent to the operation mode setting section 103. The user authentication section 106 also sends the authenticated ID information to the mode switching section 104, which then requests the operation mode setting section 103 to switch the setting to the operation mode based on the setting information acquired by the setting information acquisition section 101 in accordance with the ID information concerned, so that the personal operation mode based on the setting information concerned is set by the operation mode setting section 103 (mode change step) (S17). That is, the operation mode setting section 103 makes the setting of the personal operation mode by arranging the pieces of information created by the urgent information processing section 107a through the unread information processing section 107d on the display screen of the display section 102b based on the setting information associated with the user authenticated in the user authentication section.

By making the operation mode for setting the work environment for operation inputs selectable between different operation modes depending upon the cases where an indefinite number of general users are permitted to operate and where specific users are permitted to operate individually, it is possible for each user to perform the processing of his or her own personal information while preventing leakage of user's personal information without disturbing the use of the indefinite number of users to any substantial extent.

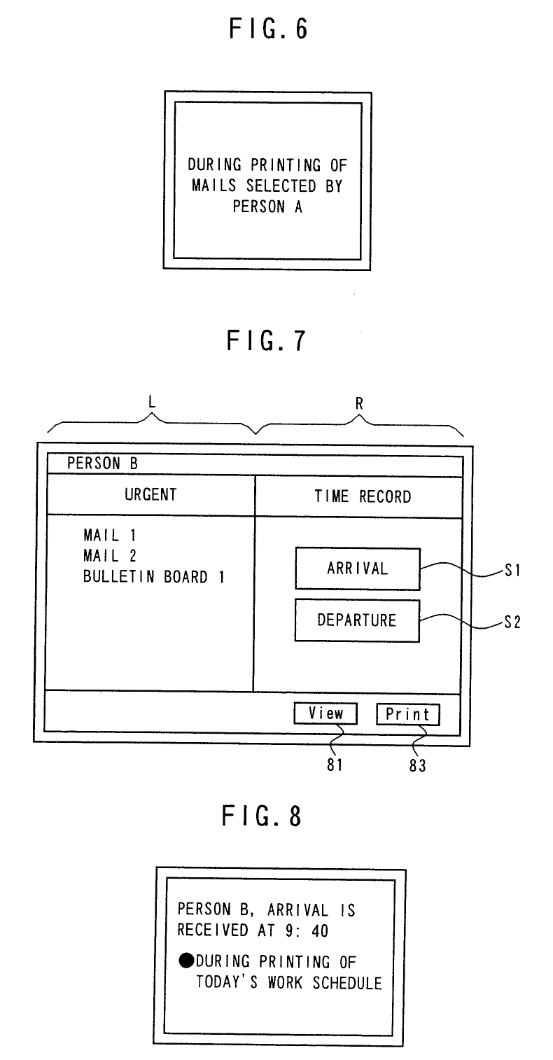

FIG. 5 illustrates a screen display example in the display section 102b in which the operation mode is set for the user of an ID “A”. As shown in this figure, a screen part or sub-screen created by the urgent information processing section is displayed at the left side L of the entire screen, whereas another screen part or sub-screen created by the schedule information processing section is displayed at the right side R of the entire screen. In addition, a “View” button 81, a “Regist” button 82 and a “Print” button 83 for basic operations on the screen are displayed at the lower side thereof. The “Print” button 83 has a role to authenticate, upon pressing thereof, ID information with respect to the scheduling management server 4 as well as to download and print the schedule information corresponding to the ID information concerned. Also, the “Regist” button 82, when pressed, performs authentication of ID information and registration of the document data read by the image reading section 108b into the document server 7, and registers a link to the corresponding date and time of the schedule (here, a link C1 is displayed as an example). FIG. 6 is a screen display example in the display section 102b when the “Print” button 83 is pressed.

FIG. 7 is a screen display example in the display section 102b in which the operation mode is set for the user of an ID “B”. As shown in this figure, a screen part or sub-screen created by the urgent information processing section is displayed at the left side L of the entire screen, whereas another screen part or sub-screen (here, the “Arrival” button S1 and the “Departure” button S2 being displayed) created by the time record information processing section is displayed at the right side R of the entire screen. In addition, the “View” button 81 and the “Print” button 83 for basic operations on the screen are displayed at the lower side thereof. The “Arrival” button S1 and the “Departure” button S2, when pressed, authenticate ID information with respect to the time record management server 5, and send the time points of pressing of these buttons to the time record management server 5. When the sending of information on each time point is completed, it is confirmed or verified whether there is a business instruction corresponding to the ID information concerned from the bulletin board server 6, and such a business instruction, if exists, is downloaded to the image processing apparatus 1 side and printed by the image forming section 108a. FIG. 8 is a screen display example in the display section 102b when the “Arrival” button S1 is pressed.

The displayed content (i.e., setting content in the setting information) on the display screen in this personal operation mode can be set arbitrarily by changing the content of setting information for each user into one such as a list of unread e-mails (messages, etc), a list of time specified e-mails such as newly arrived e-mails (messages, etc.) within the last thirty minutes or the like. Of course, it is possible to automatically make those e-mails, documents and the like, which are sent from user's superiors or from within certain groups and which include a character string “urgent” or for which special checks are to be selected, be notified to the user or be printed.

On the other hand, when the acquired ID information can not be authenticated in the verification of ID information (S13) in the user authentication section 106 (S13, No), the processing is ended.

Next, reference will be made in detail to the creation of a display screen based on the setting information.

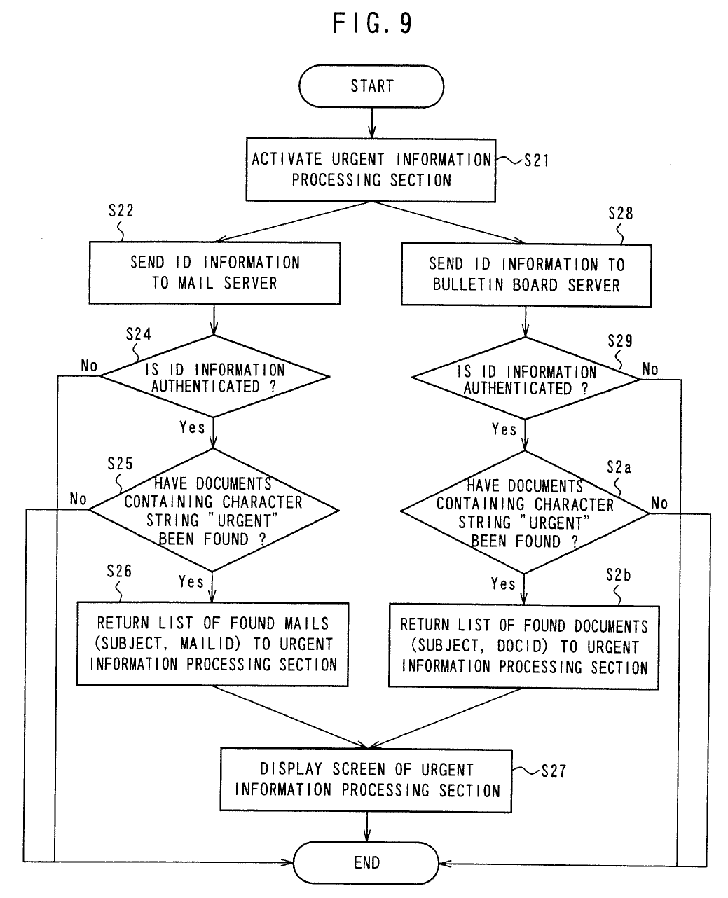

Hereinafter, reference will be made to the display screen creation processing according to the urgent information processing section 107a by using a flow chart of FIG. 9.

When the setting information acquired by the setting information acquisition section 101 includes such a setting as to let the screen created by the urgent information processing section be displayed by the display section, the urgent information processing section 107a is activated (S21).

Next, the urgent information processing section 107a sends the ID information authenticated by the user authentication section 106 to the mail server 3 and the bulletin board server 6, respectively (S22, S28).

The mail server 3 authenticates or verifies the ID information sent from the urgent information processing section 107a (S24), and searches, if authenticated, mails containing the character string “urgent” in their titles or texts among the received mails saved or stored in the mail box corresponding to the ID information (S25).

If received mails containing the character string “urgent” in their titles or texts have been found (S25, Yes), the mail server 3 sends information on a list of received mails (Subjects, Mailids) thus found to the urgent information processing section 107a (S26).

Also, the bulletin board server 6 authenticates the ID information sent from the urgent information processing section 107a (S29), and searches, if authenticated, documents which are relevant to the ID information and which contain the character string “urgent” in their titles or texts from among the messages written into the bulletin boards (S2a).

If documents containing the character string “urgent” in their titles or texts have been found (S2a, Yes), the bulletin board server 6 sends information on a list of documents (Subjects, Docids) thus found to the urgent information processing section 107a (S2b). Here, nodes that “Docid” represents the ID of each piece of document data.

The urgent information processing section 107a serves to display the respective pieces of information acquired from the mail server 3 and the bulletin board server 6 on the display section 102b in a state arranged at the screen positions set by the setting information (S27).

On the other hand, if the ID information is not authenticated in the mail server 3 (S24, No) or if the ID information is not authenticated in the bulletin board server 6 (S29, No), the processing in the server in which the ID information is not authenticated is ended.

Although the flow of the processing in the urgent information processing section 107a has been illustrated in the flow chart of FIG. 9, it is similar in the case of the unread information processing section 107d, for example, in which the user extracts unread information from the mail server 3 and the bulletin board server 6 and lets it be displayed on the display section 102b.

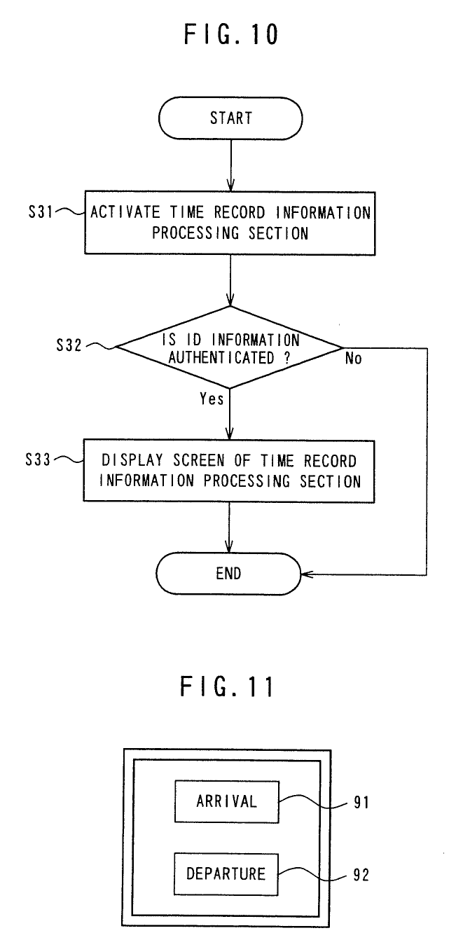

Subsequently, reference will be made to the display screen creation processing according to the time record information processing section 107c by using a flow chart of FIG. 10.

In case where the setting information acquired by the setting information acquisition section 101 contains a setting to display the screen created by the time record information processing section on the display section, the time record information processing section 107c is activated (S31).

The time record information processing section 107c sends the ID information of the user authenticated in the user authentication section 106 to the time record management server 5.

The time record management server 5 performs authentication of the ID information sent from the time record information processing section 107c (S32), and sends, if authenticated, information on user s time record (arrival and departure times) corresponding to the ID information to the time record information processing section 107c. Thus, a display screen for the information relevant to the user's time record is created by the time record information processing section 107c (see FIG. 11), and it is displayed on the display section 102b (S33).

On the other hand, in case where the ID information is not authenticated in the time record management server 5 (S32, No), this processing is ended.

Though FIG. 11 illustrates the construction that the screen on which the “Arrival” button 91 and the “Departure” button 92 alone are displayed is created in the time record information processing section 107c, the present invention is not limited to this but it is possible to create a screen on which information on the current time record (arrival and departure) status of the user of the ID authenticated is displayed.

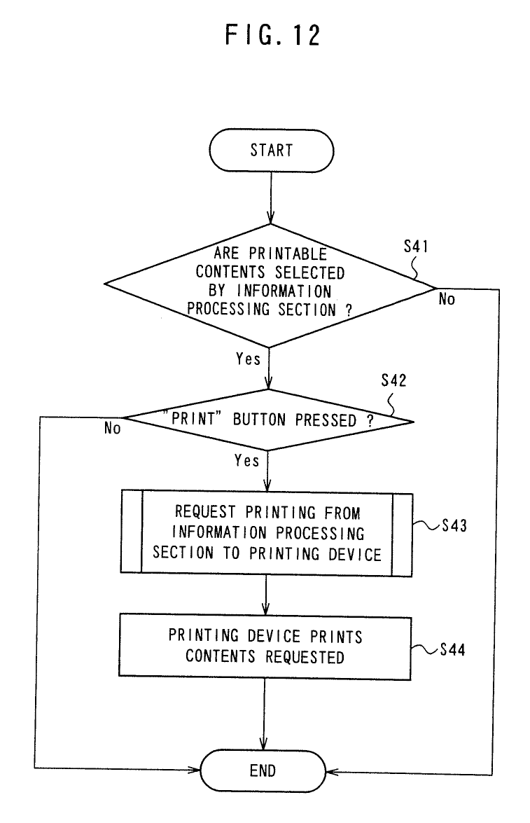

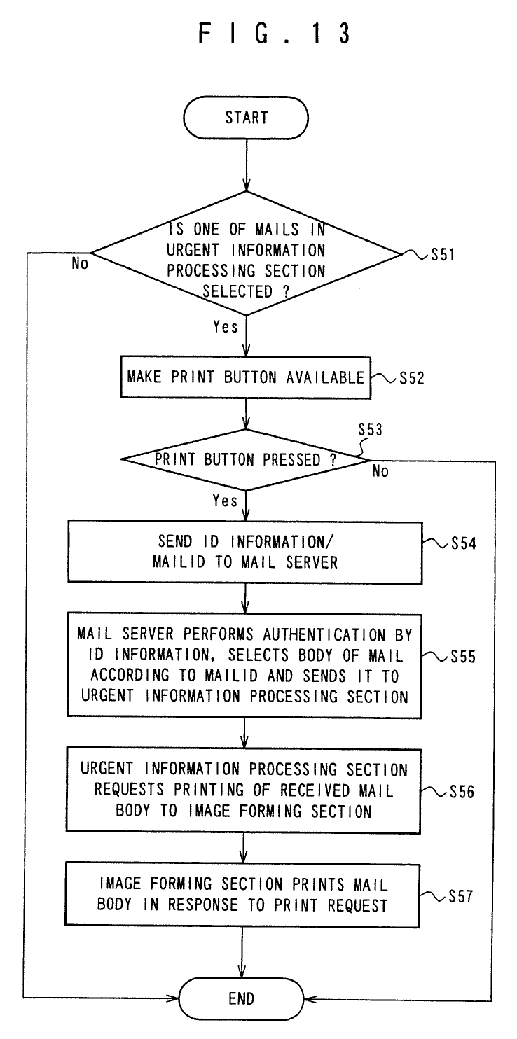

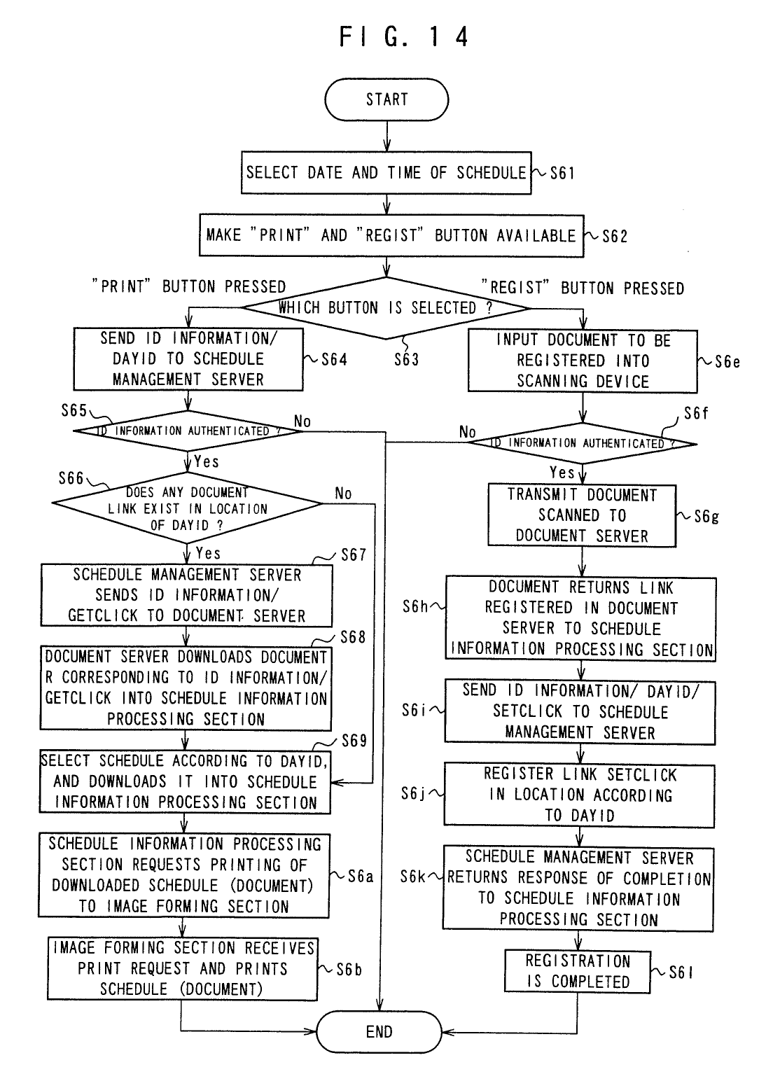

Next, reference will be made to common processing from the screen display in the display section 102b according to the urgent information processing section 107a through the unread information processing section 107d (hereinafter referred to simply as a data processing part hereinafter) to the image forming operation according to the image forming section 108a by using a flow chart shown in FIG. 12.

First of all, when printable ones from among contents displayed in the display section 102b (for example, see FIG. 5 and FIG. 7) are selected by the user through the operation input section 102a (S41), a “Print” button displayed on the display section 102b becomes in a pressable state.

Then, when this pressable “Print” button is pressed by the user (S42, Yes), the data processing part makes a request for printing the selected contents to the image forming section 108a (S43).

The image forming section 108a performs the printing of the contents for which printing has been requested (S44).

On the other hand, when any printable content is not selected (S41, No), or when the “Print” button in its pressable state is not pressed (S42, No), the processing is ended.

Next, reference will be made to the flow of the processing of printing an e-mail arbitrarily selected by the user from the e-mail list displayed on the display section 102b (for example, see FIG. 5) by the urgent information processing section 107a while using a flow chart of FIG. 13.

When the user selects at least one of printable mails from the list of mails displayed on the display section 102b by the urgent information processing section 107a (S51, Yes), the “Print” button similarly displayed on the display section 102b by the urgent information processing section 107a becomes in a selectable state (S52).

When the user presses the “Print” button (S53, Yes), the urgent information processing section 107a sends ID information and the ID (Mailid) of the selected e-mail to the mail server 3 (S54).

When the ID information sent from the urgent information processing section 107a is authenticated in the mail server 3, the data of an e-mail text matching the ID of the e-mail is selected and sent to the urgent information processing section 107a (S55).

The urgent information processing section 107a performs the print request for the data of the e-mail text sent from the mail server 3 with respect to the image forming section 108a (S56).

The image forming section 108a receives the print request from the urgent information processing section 107a, and performs image formation based on the data of the e-mail text (S57).

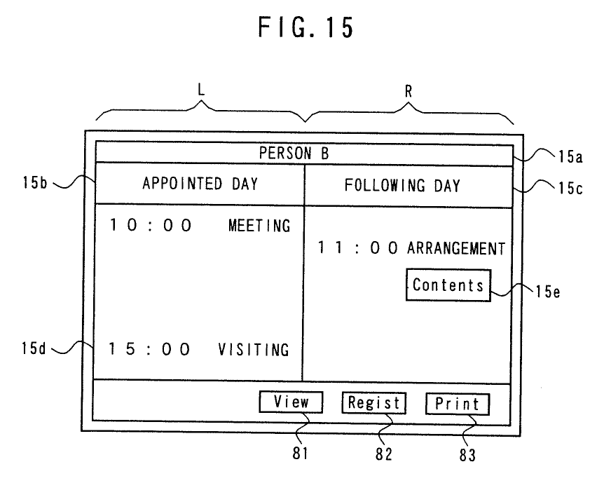

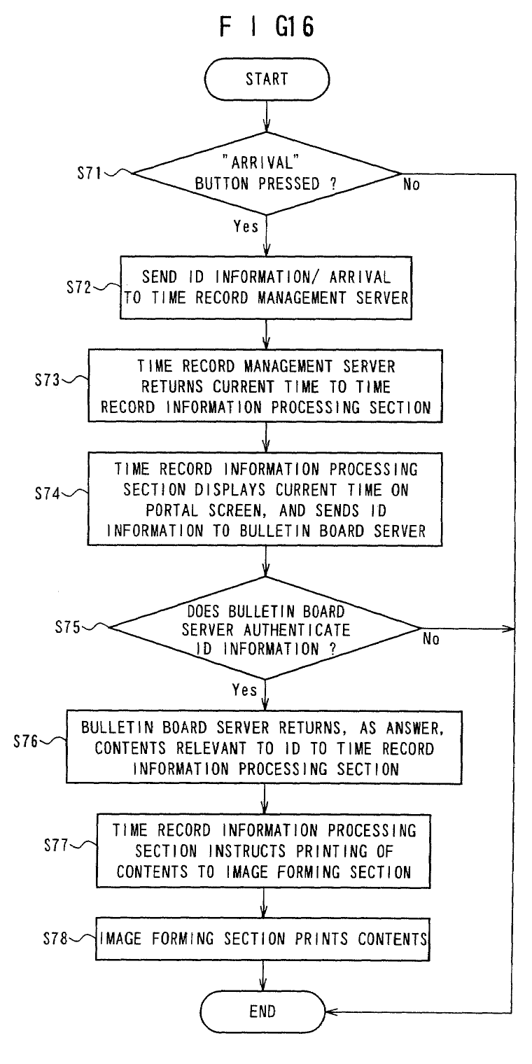

Subsequently, reference will be made to the flow of the processing of printing information on the schedule of the date and time that the user has arbitrarily selected from among schedule information (for example, see FIG. 15) displayed on the display section 102b by the schedule information processing section 107b while using a flow chart of FIG. 14.

When the user arbitrarily selects the date and time from among information on the schedule displayed on the display section 102b by the schedule information processing section 107b (S61), the “Print” button and the “Regist” button become in their selectable (pressable) states (S62).

Here, when the “Print” button is pressed (S63, “Print” button pressed), the schedule information processing section 107b sends the user's ID information and the information (dayid) for identifying the selected date and time to the schedule management server 4.

When the ID information sent from the schedule information processing section 107b is authenticated in the schedule management server 4 (S65, Yes), the schedule management server 4 verifies or determines whether there exists any document link corresponding to the dayid concerned in the data relevant to the schedule of the user of the ID information concerned (S66). On the other hand, when the ID information sent from the schedule information processing section 107b has not been authenticated in the schedule management server 4 (S65, No), the processing is ended.

When the existence of document links corresponding to the dayid concerned is verified in the schedule management server 4, (S66, Yes), the schedule management server 4 sends the ID information of the user concerned and a download request (GetClink) for linked document data with the links verified to the document server 7 (S67).

The document server 7 sends ID information sent from the schedule management server 4 and the document data corresponding to the GetClink to the schedule information processing section 107b (S68).

The schedule management server 4 selects the schedule data corresponding to the dayid concerned from among the data relevant to the schedule of the user of the ID information concerned, and sends it to the schedule information processing section 107b (S69). Here, note that when the existence of any document link corresponding to the dayid concerned is not verified in the schedule management server 4 (S66, No), the processing of this step (S69) is performed, too.

The schedule information processing section 107b requests the image formation processing of the schedule data (or document data), which have been sent from the schedule management server 4, to the image forming section 108a (S6a).

The image forming section 108a performs the image formation processing of the schedule data (or document data) based on the request concerned (S6b).

On the other hand, when the “Regist” button is pressed after selection of an arbitrary date and time (S61) (S63, “Regist” button pressed) thereby to let the image reading section 108b read the documents that the user wants to register into his or her schedule (S6e), the image data of the documents thus read is sent by the schedule management server 4 to the document server 7 (S6g) after the ID information sent from the schedule information processing section 107b has been authenticated in the schedule management server 4 (S6f, Yes).

The image data sent to the document server 7 as stated above is registered in the document server 7, which in turn sends link data corresponding to the image data concerned to the schedule information processing section 107b (S6h).

The schedule information processing section 107b sends the ID information of the user concerned, information (dayid) to identify the selected date and time, and link data (SetClink) corresponding to the read image data to the schedule management server 4 (S6i).

The schedule management server 4 registers the links of the image data of the documents read by the image reading section 108b in the data relevant to the schedule of the user of the ID information concerned based on the ID information, dayid, and SetClink sent from the schedule information processing section 107b (S6j).

The schedule management server 4 notifies the schedule information processing section 107b to the effect that in the above step (S6j), the registration of the links of the image data of the documents has been completed (S6k), and the processing of registering the documents in the schedule is completed (S61).

When the ID information sent from the schedule information processing section 107b has not been authenticated in the schedule management server 4 (S6f, No), the processing is ended.

Here, note that when a “Person B” 15a has been selected in the display screen shown in FIG. 15 and the “Print” button 83 has been pressed, schedules for today and the following day, details of the schedules concerned, and relevant documents registered if exist are printed.

In addition, when the “Person B” 15a is selected and the “Regist” button 82 is pressed, a link (“Contents”) is set to an area of the “Person B” 15a.

Then, when a “Today” 15b or a “Following Day” 15c is selected and the “Print” button 83 is pressed, a schedule for today or the following day, details of the schedule concerned, and documents registered for the schedule concerned if exist are printed.

Moreover, when the “Today” 15b or the “Following Day” 15c is selected and the “Regist” button 82 is pressed, a link (“Contents”) is set to an area of the “Today” 15b or the “Following Day” 15c.

When a “Time Point” 15d is selected and the “Print” button 83 is pressed, a schedule for the time point, details of the schedule concerned, and documents registered for the schedule if exist are printed.

In addition, when the “Time Point” 15d is selected and the “Regist” button 82 is pressed, a link (“Contents”) is set to an area of the “Time Point” 15d (see a reference symbol 15e).

Next, it is explained by flow the processing (time card management of the time record (arrival and departure) etc. that use the bulletin board system) when do registration processing of going to work or the retire from one's office by the (see FIG. 7) on the screen displayed on the display section 102b by the time record information processing section 107c using the flow chart of FIG. 16.

When the “Arrival” button S1 is pressed by the user whose ID information has been authenticated (S71, Yes), the time record information processing section 107c sends to the time record management server 5 information to the effect that the ID information and “Arrival” are registered (S72), whereas when the “Arrival” button S1 is not pressed, the processing is ended (S71, No).

Upon receipt of the ID information or the like from the time record information processing section 107c, the time record management server 5 inputs the current time into a time record list corresponding to the ID information concerned in the database managed by the time record management server 5, and sends the current time to the time record information processing section 107c (S73).

The time record information processing section 107c displays the current time on the screen displayed on the display section 102b, and sends the ID information of the user concerned to the bulletin board server 6 (S74).

The bulletin board server 6 authenticates the ID information sent from the time record information processing section 107c (S75).

When the ID information has been authenticated by the bulletin board server 6 (S75, Yes), the information relevant to the bulletin board managed in the bulletin board server 6 and the ID information concerned are verified or collated against a current time t, and if there exist contents corresponding to the current time t, the data of the contents is sent to the time record information processing section 107c (S76).

On the other hand, when the ID information has not been authenticated in the bulletin board server 6 (S75, No), the processing is ended.

The time record information processing section 107c requests the image formation processing of the contents sent from the bulletin board server 6 to the image forming section 108a (S77).

The image forming section 108a prints the contents concerned upon receipt of the print request (S78).

Subsequently, reference will be made to the processing when the operation mode is again switched into the public operation mode after the operation mode has been switched from the public operation mode into the personal operation mode.

In this embodiment, the mode switching section 104 is constructed such that it switches the operation mode from the personal operation mode to the public operation mode based on a prescribed condition when the current operation mode is set to the personal operation mode through personal authentication.

By making it possible to switch the operation mode into the public operation mode based on the prescribed condition in this manner, the situation that an indefinite number of users operate the apparatus with the operation mode set to the personal operation mode can be avoided.

Here, such a prescribed condition for switching from the personal operation mode into the public operation mode includes, among others, the case where ID information has not been acquired in the user authentication section 106 for a period of time longer than a predetermined time. For example, in cases where ID information can be acquired in the user authentication section only when the user performs operation in the image processing apparatus (e.g., in case of personal authentication being performed by a user's fingerprint, or personal authentication being able to be made only during the time when an ID card is being read by the card reader, or the like), it is possible to avoid the situation where when the user, who had been operating the apparatus in the personal operation mode was away from the apparatus with its operation mode being kept set to the personal operation mode for the predetermined time or more, or when the user finished the operation inadvertently while having forgotten that the apparatus had been set to the personal operation mode, or in other like cases, an indefinite number of other users operate the apparatus with its operation mode being set to the personal operation mode.

Besides these, the prescribed condition for switching from the personal operation mode to the public operation mode can be constructed as follows. That is, the human body detection section 105 starts to detect the existence of the user concerned in the vicinity of the image processing apparatus 1 from the time point at which user's ID information is authenticated in the user authentication section (human body detection step), and when the human body detection section 105 has not detected the human body for a period of time longer than a predetermined time, the operation mode is switched from the personal operation mode into the public operation mode.

According to such a construction, when the user, who had been operating the apparatus in the personal operation mode was away from the apparatus with its operation mode being kept set to the personal operation mode for a predetermined time or more, or when the user finished the operation inadvertently while having forgotten that the apparatus had been set to the personal operation mode, it is possible to avoid the situation where an indefinite number of users operate the apparatus with its operation mode being set to the personal operation mode. In addition, it is also possible to contribute to the reduction in size of the apparatus by using in combination therewith a human body detection sensor, etc., that is utilized to determine the stand-by state of the image processing apparatus or the like.

Moreover, according to the present invention, there is provided a personal information management method which is stored in a computer-readable medium so as to perform the management of personal information in an image processing apparatus shared by a plurality of users, the personal information management method comprising: a user authentication step that acquires ID information to identify each user from among a plurality of users, and performing user authentication based on the ID information: an operation mode setting step that selectively sets, as an operation mode that sets a work environment for operation inputs, between an personal operation mode to permit each user to operate individually and a public operation mode to permit an indefinite number of users to operate; and a mode switching step that, when a user is authenticated in the user authentication step, switches the operation mode from the public operation mode into the personal operation mode for the authenticated user.

Further, in the personal information management method as stated above, it is preferred that in the mode switching step, the operation mode be switched from the personal operation mode into the public operation mode based on a prescribed condition with the state that a current operation mode is set to the personal operation mode.

Furthermore, in the personal information management method as stated above, in the mode switching step, when ID information is not acquired for a period of time longer than a predetermined time in the user authentication step, the operation mode can be switched from the personal operation mode into the public operation mode with the state condition that a current operation mode is set to the personal operation mode.

Still further, in the personal information management method as stated above, provision is further made for a human body detection step for detecting a user located in the vicinity of the image processing apparatus, wherein in the mode switching step, when a human body has not been detected in the human body detection step for a period of time longer than a predetermined time, the operation mode may be switched from the personal operation mode into the public operation mode with the state that a current operation mode is set to the personal operation mode.

Besides, in the personal information management method as stated above, provision can be further made for a setting information acquisition step that acquires setting information associated with each user, wherein in the operation mode setting step, the personal operation mode is set based on the setting information associated with the user authenticated in the user authentication step.

In addition, in the personal information management method as stated above, the ID information cooperates with login IDs in a network that can be connected to the image processing apparatus, wherein the personal information management program may further comprise a personal information processing step that performs the processing of personal information relevant to the users corresponding to the ID information existing on the network based on the ID information.

Here, note that each step of the personal information management method in the present invention is achieved by storing a personal information management program according to the present invention in an unillustrated storage section in an image processing apparatus or a recording medium that can be read by an unillustrated CPU (computer), and making the unillustrated CPU execute the program.

Specifically, a personal information management program according to the present invention is constructed such that personal information management program, which is adapted to be stored in a computer-readable medium so as to perform the management of personal information in an image processing apparatus shared by a plurality of users, serves to make a computer execute: a user authentication step that acquires ID information to identify each user from among a plurality of users, and performing user authentication based on the ID information: an operation mode setting step that selectively sets, as an operation mode that sets a work environment for operation inputs, between an personal operation mode to permit each user to operate individually and a public operation mode to permit an indefinite number of users to operate; and a mode switching step that, when a user is authenticated in the user authentication step, switches the operation mode from the public operation mode into the personal operation mode for the authenticated user.

Moreover, preferably, in the personal information management program as stated above, it is preferred that in the mode switching step, the operation mode be switched from the personal operation mode into the public operation mode based on a prescribed condition with the state that a current operation mode is set to the personal operation mode.

In addition, in the personal information management program as stated above, in the mode switching step, when ID information is not acquired for a period of time longer than a predetermined time in the user authentication step, the operation mode can be switched from the personal operation mode into the public operation mode with the state condition that a current operation mode is set to the personal operation mode.

Further, in the personal information management program as stated above, provision is further made for a human body detection step for detecting a user located in the vicinity of the image processing apparatus, wherein in the mode switching step, when a human body has not been detected in the human body detection step for a period of time longer than a predetermined time, the operation mode may be switched from the personal operation mode into the public operation mode with the state that a current operation mode is set to the personal operation mode.

Besides, in the personal information management program as stated above, provision can be further made for a setting information acquisition step that acquires setting information associated with each user, wherein in the operation mode setting step, the personal operation mode is set based on the setting information associated with the user authenticated in the user authentication step.

Furthermore, preferably, in the personal information management program as stated above, the ID information cooperates with login IDs in a network that can be connected to the image processing apparatus, wherein the personal information management program may further comprise a personal information processing step that performs the processing of personal information relevant to the users corresponding to the ID information existing on the network based on the ID information.

Although in the embodiment of the present invention, there has been described the case where functions to achieve the invention are prerecorded in the interior of the apparatus, the present invention is not limited to this but similar functions can be downloaded into the device or system via a network. Alternatively, a recording medium storing therein similar functions can be installed in the apparatus. The recording medium can be of any form, such as for example a CD-ROM, which is able to store programs and which is able to be read out by the apparatus. In addition, the functions to be obtained by such preinstallation or downloading can be achieved through cooperation with an OS (operating system) or the like in the interior of the apparatus.

Even if an important e-mails or information has reached a user, it may sometimes be overlooked when the user leaves his or her seat, such as going out. In order to avoid such a situation, it becomes possible for the user to perform user authentication in the shared or common image processing apparatus before leaving his or her seat, so that the user can display, print and save into a file a list of received e-mails addressed to the user concerned inside a company or in-house system, or the contents of user's schedule and the bulletin board of a groupware.

Moreover, it can be constructed such that files, etc., are linked with the schedules of individual users and the schedules of user groups, so that the files, which should be printed out so as be carried on by a user when the user is attending a meeting or going out, are notified to the user in the form of a message “There are documents for which printing is necessary,” by performing personal authentication at the image processing apparatus when the user leaves his or her seat. Additionally, in case where the number of participants to a meeting, etc., is managed by a schedule management server, it is possible to instruct printout of hard copies for the number of participants.

As described in detail above, according to the present invention, it is possible to provide an image processing apparatus and a personal information management program which can permit each user to perform the processing of user's own personal information while preventing leakage of user's personal information without disturbing the use of the apparatus by an infinite number of users to any substantial extent.

What is claimed is:

1. An image processing apparatus having a stand-by state which ID information can be inputted comprising:
a user authentication section that compares the ID information inputted with data for ID information authentication;
an operation mode setting section that sets a first operation mode when a user is authenticated by the user authentication section; and
a mode switching section that switches to the stand-by state when the image processing apparatus is not operated for a period of time longer than a predetermined time during the first operation mode.

2. The image processing apparatus as set forth in claim 1, further comprising a second operation mode that can be operated without performing the user authentication by the user authentication section.

3. A method of personal information management of an image processing apparatus having a stand-by state which ID information can be inputted comprising:
comparing the ID information inputted with data for ID information authentication;
setting a first operation mode when a user is authenticated by the user authentication section; and
switching to the stand-by state when the image processing apparatus is not operated for a period of time longer than a predetermined time during the first operation mode.

4. The method as set forth in claim 3, wherein the image processing apparatus further comprises a second operation mode that can be operated without performing the user authentication by the user authentication section.
